(19) United States
(12) Patent Application Publication
(10) Pub. No.: US 2007/0192330 A1
(43) Pub. Date: Aug. 16, 2007

(54) INFORMATION PROCESSING APPARATUS AND METHOD AND PROGRAM

(75) Inventors: Mizuki Kanada, Kanagawa (JP); Toshiaki Kojima, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-Ku (JP)

(21) Appl. No.: 11/625,589

(22) Filed: Jan. 22, 2007

(30) Foreign Application Priority Data
Jan. 27, 2006 (JP) 2006-018977

(51) Int. Cl. G06F 17/30

(52) U.S. Cl. 707/10

(57) ABSTRACT

An information processing apparatus which functions, in a network environment wherein data is communicated between a server and a client, as an end point on the server side or the client side, includes a setter and a controller. The setter is configured to set at least a permissible maximum latency as a parameter representative of a nature of the network which is to be used on the client side. The controller is configured to perform real time control of data of an object of transmission or reception based on the parameter set by the setter to control a transmission or reception process of the data.

### CROSS REFERENCES TO RELATED APPLICATIONS

The present invention contains subject matter related to Japanese Patent Application JP 2006-018977 filed with the Japanese Patent Office on Jan. 27, 2006, the entire contents of which being incorporated herein by reference.

### BACKGROUND OF THE INVENTION

1. Field of the Invention

This invention relates to an information processing apparatus and method and a program, and more particularly to an information processing apparatus and method and a program suitable for use with a communication environment wherein a large amount of data and control command data and so forth for which a high real time performance is demanded are involved in a mixed manner.

2. Description of the Related Art

Such techniques as Intserv and Diffserv are available as a priority control technique or a quality providing technique for the Internet. The Intserv uses a protocol called RSVP (Resource Reservation Protocol) to assure a band between ends in order to assure the QoS (Quality of Service) The Intserv has not yet been placed into practical use from the complexity or scalability of the RSVP and the difficulty in implementation. Meanwhile, according to the Diffserv, a router of a network performs packet scheduling in accordance with the value of the DSCP field in the IP (Internet Protocol) header in order to implement relative QoS assurance.

Meanwhile, a technique of achieving higher speed processing at an end point of a network environment in order to achieve a real time performance is disclosed in Japanese Patent Laid-Open No. 2003-143221 (hereinafter referred to as Patent Document 1). According to the technique of Patent Document 1, a TCP/IP (Transmission Control Protocol/Internet Protocol) process is passed from software which operates under the control of an OS (Operating System) to hardware for exclusive use. Consequently, a protocol process can be executed without being disturbed by a task controlled by the OS, and a high real time performance in network communication is achieved thereby.

The real time performance signifies to satisfy a restrictive condition that a predetermined process has to be completed within a fixed period of time, that is, a restrictive time condition.

### SUMMARY OF THE INVENTION

However, both of the techniques of the Intserv and the Diffserv are directed to control along an end-to-end route but not to a priority control process in the inside of an end point. Therefore, both techniques have a problem that it is very difficult to achieve a real time performance desired by a user in a communication environment wherein a large amount of data and control command data and so forth for which a high real time performance is demanded are involved in a mixed manner.

Meanwhile, the technique of Patent Document 1 does not involve priority control in processing itself. Therefore, the technique of Patent Document 1 has a problem that it is very difficult to achieve a real time performance desired by a user in a communication environment wherein a large amount of data and control command data and so forth for which a high real time performance is demanded are involved in a mixed manner.

Thus, according to the present technical situation, even if the technique of the Intserv or Diffserv and the technique of Patent Document 1 are combined, the problem that it is very difficult to achieve a real time performance desired by a user in a communication environment wherein a large amount of data and control command data and so forth for which a high real time performance is demanded are involved in a mixed manner may not be solved.

Therefore, it is demanded to provide an information processing apparatus and method and a program by which a real time performance desired by a user can be implemented in a communication environment wherein a large amount of data and control command data and so forth for which a high real time performance is demanded are involved in a mixed manner.

According to an embodiment of the present invention, there is provided an information processing apparatus which functions, in a network environment wherein data is communicated between a server and a client, as an end point on the server side or the client side, including a setter configured to set at least a permissible maximum latency as a parameter representative of a nature of the network which is to be used on the client side, and a controller configured to perform real time control of data of an object of transmission or reception based on the parameter set by the setter to control a transmission or reception process of the data.

The setter may further set a priority degree as another parameter.

In this instance, the setter may further set a used band as a further parameter.

The information processing apparatus may function as an end point on the client side and further include a generator configured to generate notification data for notifying the server side of the parameter set by the setter as one of data of the transmission object.

In this instance, the generator may perform a packetization process according to the Transmission Control Protocol/Internet Protocol (TCP/IP) or the User Datagram Protocol/Internet Protocol (UDP/IP) to generate the notification data as a packet.

In this instance, the information processing apparatus may be configured such that a predetermined one port number is allocated in advance to each of values which can be taken by the parameter, the setter converting each of the set values of the parameter into a port number coordinated with the value, the generator generating the packet of the notification data using a socket which includes the port number converted from the value of the parameter by the setter.

Or, the generator may generate a packet wherein the value of the parameter set by the setter is described in a data region as the notification data.

The information processing apparatus may be configured such that the information processing apparatus functions as an end point on the server side, and when the information processing apparatus receives, from the client side, data obtained by converting the parameter set by the client side into data of a form in which the data is transmitted and received in the network environment, the setter sets the parameter based on the received data.

According to another embodiment of the present invention, there is provided an information processing method for an information processing apparatus which functions, in a network environment wherein data is communicated between a server and a client, as an end point on the server side or the client side, including the steps of setting at least a permissible maximum latency as a parameter representative of a nature of the network which is to be used on the client side, and performing real time control of data of an object of transmission or reception based on the set parameter to control a transmission or reception process of the data.

According to a further embodiment of the present invention, there is provided a program which corresponds to the information processing method described above.

In the information processing method and apparatus and the program, where data is communicated between a server and a client in a network environment, the following process is executed by an end point on the server side or the client side. In particular, at least a permissible maximum latency is set as a parameter representative of a nature of the network which is to be used on the client side. Then, real time control of data of an object of transmission or reception is performed based on the set parameter to control a transmission or reception process of the data.

With the information processing method and apparatus and the program, a process which involves communication of data between the server and the client can be executed. Particularly, upon execution of the process, a real time performance desired by the user can be implemented in such a communication environment that a large amount of data and control command data and so forth for which a high real time performance is demanded are involved in a mixed manner.

### BRIEF DESCRIPTION OF THE DRAWINGS

FIG. 1 is a block diagram showing an example of a configuration of an information processing system to which the present invention is applied;

FIG. 2 is a block diagram showing an example of a hardware configuration of a communication apparatus shown in FIG. 1 which is an information processing apparatus to which the present invention is applied;

FIG. 3 is a block diagram showing an example of a hardware configuration of a communication section of the communication apparatus of FIG. 2;

FIG. 4 is a functional block diagram showing an example of a functional configuration of the communication apparatus of FIG. 2;

FIG. 5 is a flow chart illustrating an example of a client side RTP setting process from within processing executed by the communication apparatus of FIG. 4;

FIG. 6 is a view illustrating an example of an RTP-client side port number conversion table;

FIG. 7 is a flow chart illustrating an example of a real time control process for client side data transmission from within the processing executed by the communication apparatus of FIG. 4;

FIG. 8 is a flow chart illustrating an example of a real time control process for client side data reception from within the processing executed by the communication apparatus of FIG. 4;

FIG. 9 is a flow chart illustrating an example of a real time control process for RTP setting and data reception by the server side based on data from the client side from within the processing executed by the communication apparatus of FIG. 4;

FIG. 10 is a flow chart illustrating an example of a real time control process for server side data transmission from within the processing executed by the communication apparatus of FIG. 4;

FIG. 11 is a functional block diagram showing an example of a functional configuration of the communication apparatus of FIG. 2 different from that shown in FIG. 4;

FIG. 12 is a diagrammatic view illustrating an example of a structure of an RTP notification packet;

FIG. 13 is a diagrammatic view illustrating a different example of a structure of an RTP notification packet from that shown in FIG. 12;

FIG. 14 is a flow chart illustrating an example of an RTP setting process by the client side from within processing executed by the communication apparatus of FIG. 11;

FIG. 15 is a flow chart illustrating an example of a server side reception process from within the processing executed by the communication apparatus of FIG. 11;

FIG. 16 is a flow chart illustrating an example of details of an RTP setting process by the server side from within the server side reception process of FIG. 15;

FIG. 17 is a flow chart illustrating an example of details of a real time control process for server side data reception by the server side from within the server side detection process of FIG. 15;

FIG. 18 is a functional block diagram showing an example of a functional configuration of the communication apparatus of FIG. 2 different from those of FIGS. 4 and 11;

FIGS. 19 and 20 are flow charts illustrating an example of a data transmission process by transmission timing control on the client side from within processing executed by the communication apparatus of FIG. 18;

FIG. 21 is a flow chart illustrating an example of a data transmission process by transmission timing control on the server side from within the processing executed by the communication apparatus of FIG. 18;

FIG. 22 is a functional block diagram showing an example of a functional configuration of the communication apparatus of FIG. 2 different from those shown in FIGS. 4, 11 and 18; and

FIGS. 23 and 24 are flow charts illustrating an example of a data transmission process by transmission timing control by the client side from within the processing executed by the communication apparatus of FIG. 22.

### DETAILED DESCRIPTION OF THE PREFERRED EMBODIMENT

Before a preferred embodiment of the present invention is described in detail, a corresponding relationship between several features recited in the accompanying claims and particular elements of the preferred embodiment described below is described. The description, however, is merely for the confirmation that the particular elements which support the invention as recited in the claims are disclosed in the description of the embodiment of the present invention. Accordingly, even if some particular element which is recited in description of the embodiment is not recited as one of the features in the following description, this does not signify that the particular element does not correspond to the feature. On the contrary, even if some particular element is recited as an element corresponding to one of the features, this does not signify that the element does not correspond to any other feature than the element.

Further, the following description does not signify that the prevent invention corresponding to particular elements described in the embodiment of the present invention is all described in the claims. In other words, the following description does not deny the presence of an invention which corresponds to a particular element described in the description of the embodiment of the present invention but is not recited in the claims, that is, the description does not deny the presence of an invention which may be filed for patent in a divisional patent application or may be additionally included into the present patent application as a result of later amendment to the claims.

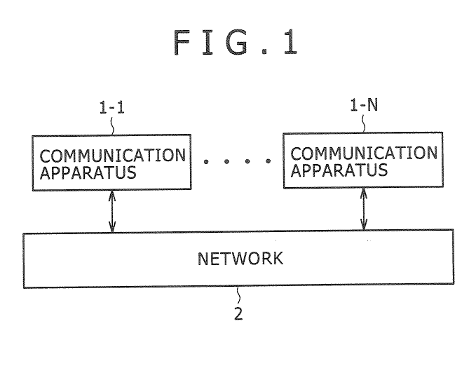

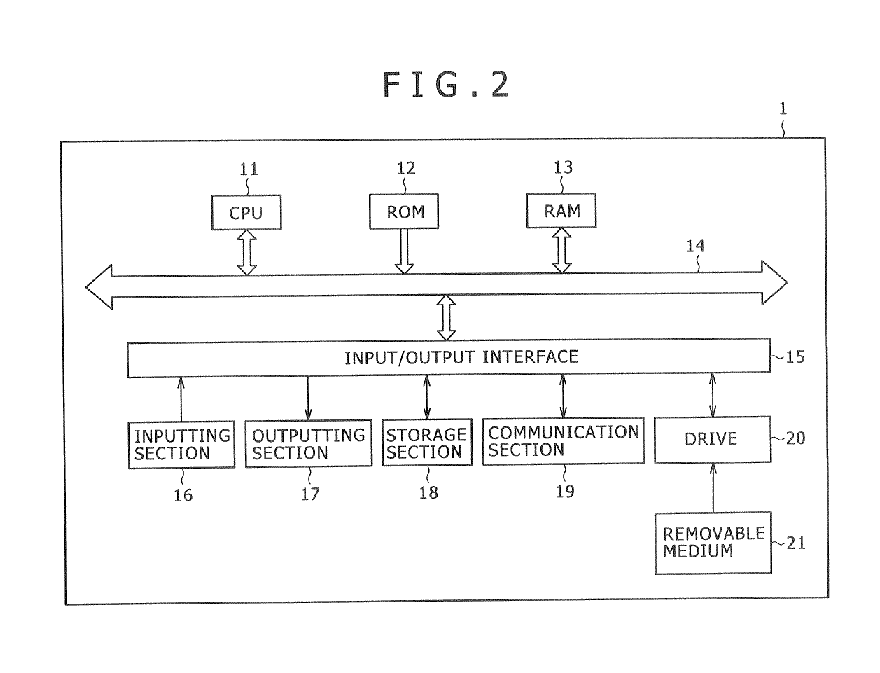

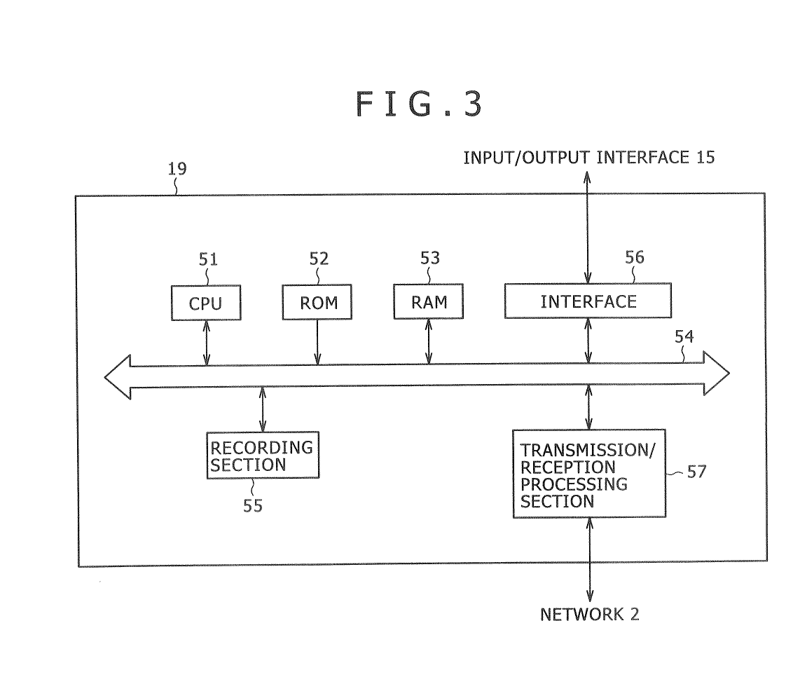

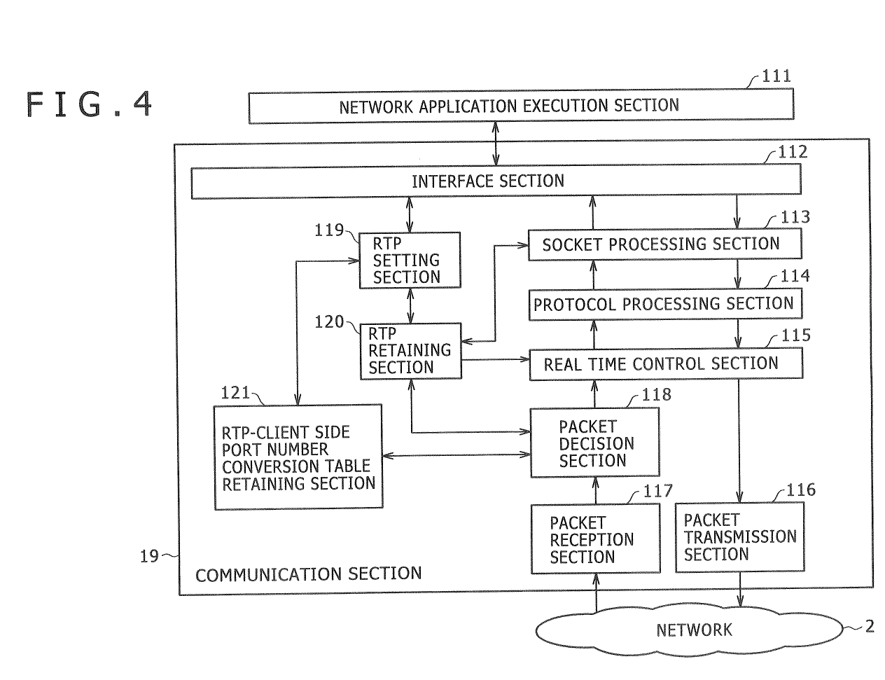

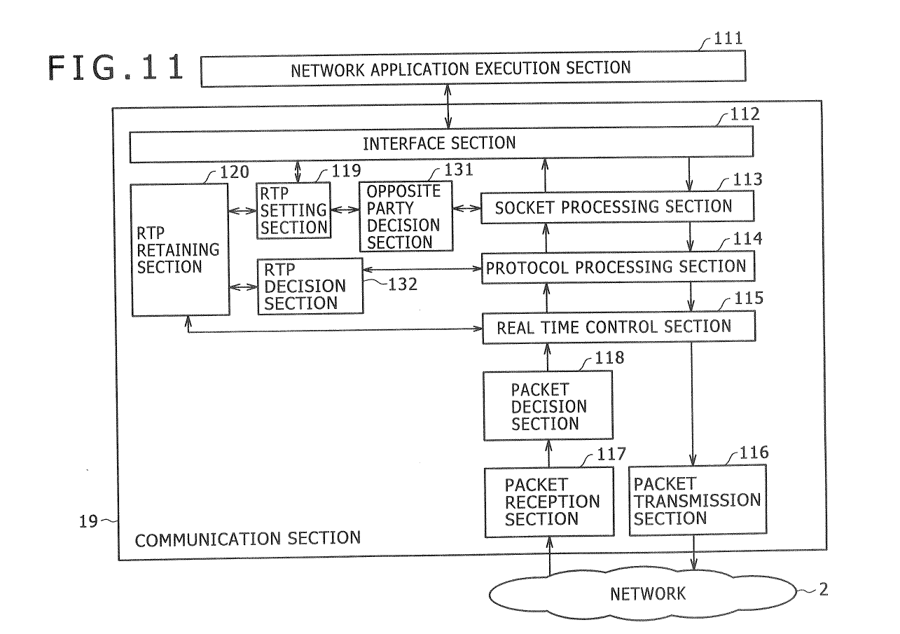

According to an embodiment of the present invention, there is provided an information processing apparatus (for example, an apparatus which is incorporated as a communication section 19 shown in FIG. 2 and has a hardware configuration of FIG. 3 and a functional configuration shown in FIG. 4, 11, 18 or 22; in the following description, for simplified description, a corresponding relationship is described only with regard to the apparatus which has the functional configuration of FIG. 4 or 11) which functions, in a network environment (for example, a communication environment by a network 2 shown in FIG. 1) wherein data is communicated between a server and a client (for example, wherein data is communicated between two of communication apparatus 1-1 to 1-N), as an end point on the server side or the client side, including a setter (for example, an RTP setting section 119 shown in FIG. 4 or 11 where the information processing apparatus functions as the client side, or a packet decision section 119 shown in FIG. 4 or 11 where the information processing apparatus functions as the server side) configured to set at least a permissible maximum latency as a parameter representative of a nature of the network which is to be used on the client side, and a controller (for example, a real time control section 115 shown in FIG. 4 or 11) configured to perform real time control of data of an object of transmission or reception based on the parameter set by the setter to control a transmission or reception process of the data.

The information processing apparatus functions as an end point on the client side and further includes a generator (for example, a protocol processing section 114 shown in FIG. 4) configured to generate notification data for notifying the server side of the parameter set by the setter as one of data of the transmission object.

The generator performs a packetization process according to the Transmission Control Protocol/Internet Protocol (TCP/IP) or the User Datagram Protocol/Internet Protocol (UDP/IP) to generate the notification data as a packet.

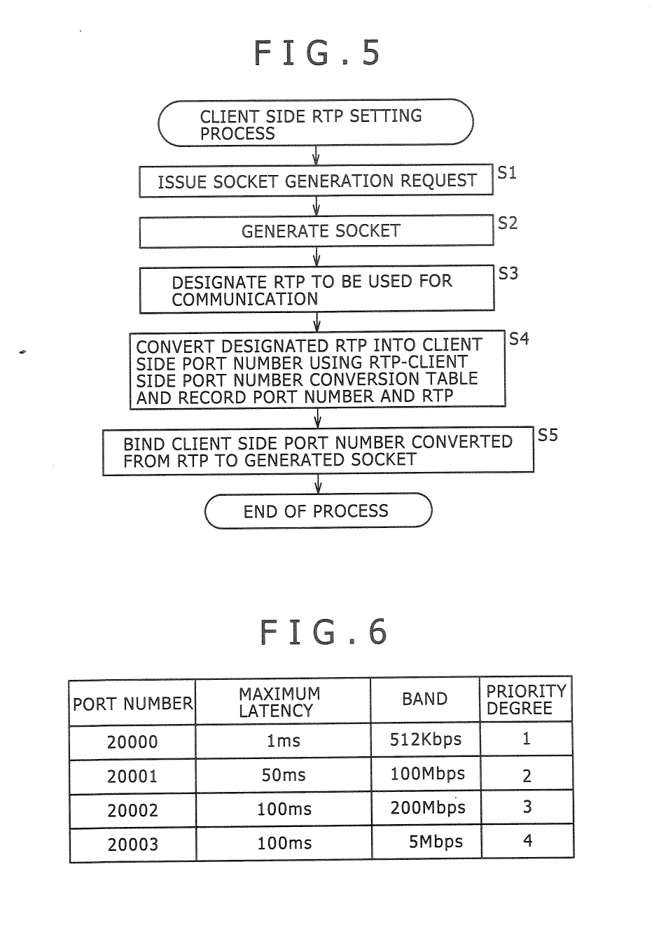

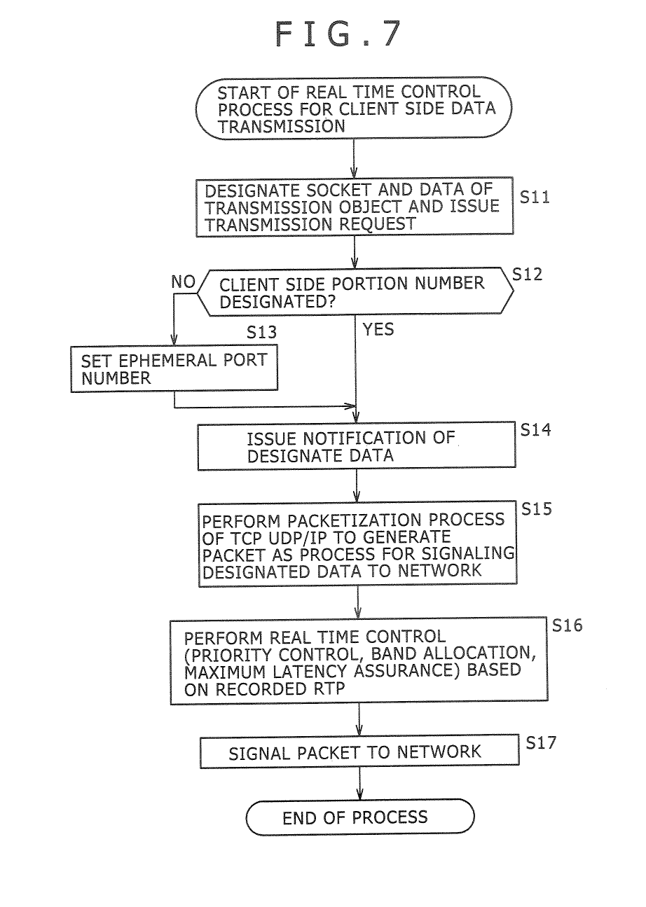

In this instance, where the information processing apparatus has the functional configuration shown in FIG. 4, a predetermined one port number is allocated in advance to each of values which can be taken by the parameter (for example, refer to a table of FIG. 6). Further, the setter converts each of the set values of the parameter into a port number coordinated with the value (for example, step S4 of FIG. 5), and the generator generates the packet of the notification data using a socket (for example, step S5 of FIG. 5) which includes the port number converted from the value of the parameter by the setter (for example, step S15 of FIG. 7).

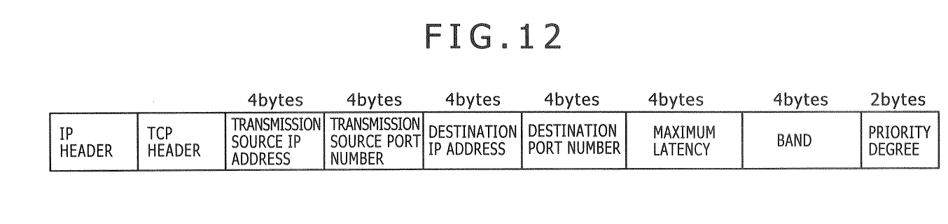

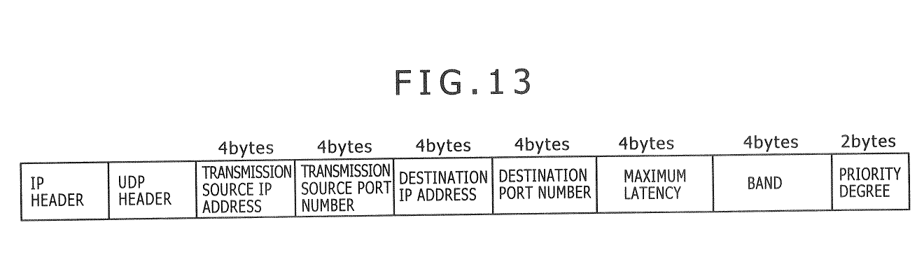

Or, where the information processing apparatus has the functional configuration shown in FIG. 11, the generator generates the packet (for example, an RTP notification packet of a structure illustrated in FIG. 12 or 13) described the value of the parameter set by the setter in a data region as the notification data.

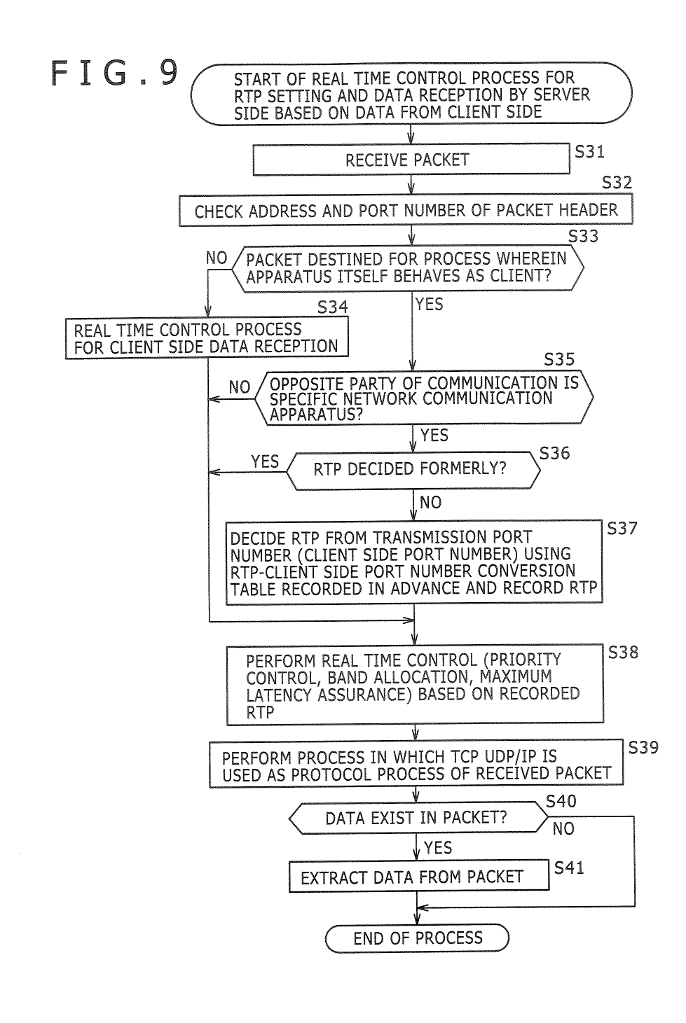

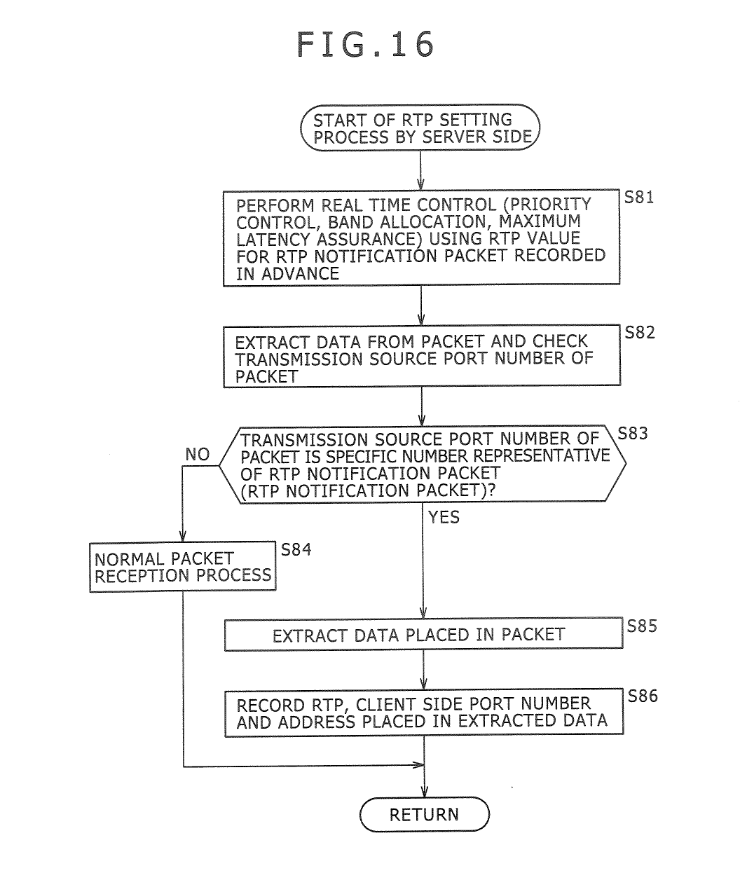

The information processing apparatus functions as an end point on the server side, and when the information processing apparatus receives, from the client side, data obtained by converting the parameter set by the client side into data of a form in which the data is transmitted and received in the network environment, the setter sets the parameter based on the received data (for example, step S37 of FIG. 9 or steps S85 and S86 of FIG. 16).

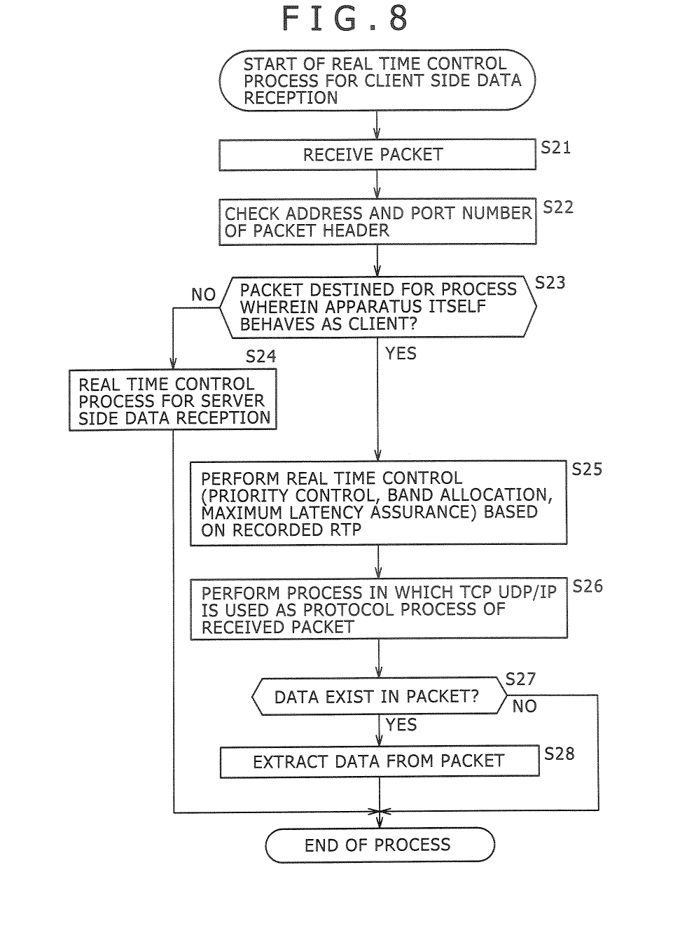

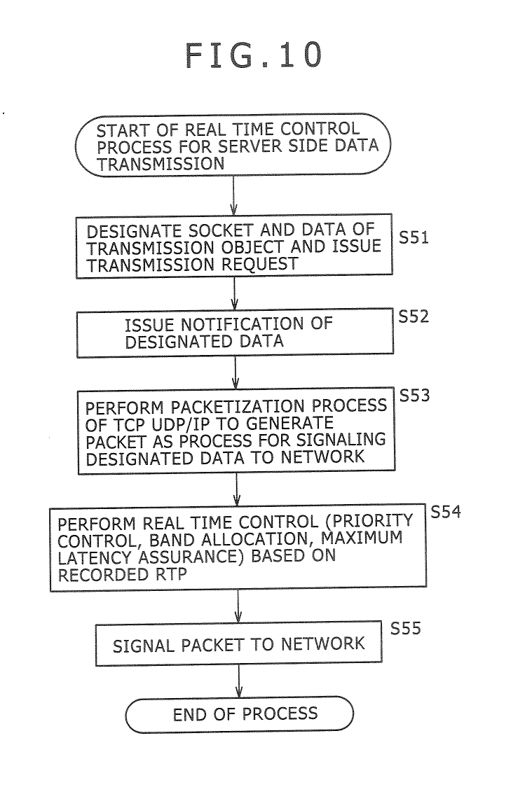

According to another embodiment of the present invention, there is provided an information processing method for an information processing apparatus (for example, an information processing method for an apparatus which corresponds to a communication section 19 shown in FIG. 2 and has a hardware configuration of FIG. 3 and a functional configuration shown in FIG. 4, 11, 18 or 22; in the following description, for simplified description, a corresponding relationship is described only with regard to the information processing method for the apparatus which has the functional configuration of FIG. 4) which functions, in a network environment wherein data is communicated between a server and a client, as an end point on the server side or the client side, including the steps of setting at least a permissible maximum latency as a parameter representative of a nature of the network which is to be used on the client side (for example, an RTP setting process on the client side of FIG. 5 where the apparatus functions as the client side, or step S37 of FIG. 9 where the apparatus functions as the server side), and performing real time control of data of an object of transmission or reception based on the set parameter to control a transmission or reception process of the data (for example, step S16 of FIG. 7 or step S25 of FIG. 8 where the apparatus functions as the client side, or step S38 of FIG. 9 or step S54 of FIG. 10 where the apparatus functions as the server side).

According to a further embodiment of the present invention, there is provided a program which corresponds to the information processing method described above and is executed, for example, by a computer which includes a CPU 51 shown in FIG. 3, described later.

In the following, an embodiment of the present invention is described with reference to the accompanying drawings.

FIG. 1 shows an example of a configuration of an information processing system to which the present invention is applied.

Referring to FIG. 1, the information processing system shown includes N (N is an arbitrary integral value equal to or greater than 2) communication apparatus 1-1 to 1-N. The communication apparatus 1-1 to 1-N are connected to each other by a network 2 in such a manner that they can communicate with each other through the network 2.

It is to be noted that, in the present specification, one of the communication apparatus 1-1 to 1-N which issues a request for communication is referred to as client, and another one of the communication apparatus 1-1 to 1-N to which the request for communication is issued is referred to as server. In other words, each of the communication apparatus 1-1 to 1-N may function as a server or as a client depending upon the relationship thereof with the opposite party of communication which is another one of the communication apparatus 1-1 to 1-N. Further, where any of the communication apparatus 1-1 to 1-N has a plurality of opposite parties of communication, it may function both as a server and a client simultaneously.

Further, in the following description, where there is no necessity to distinguish the communication apparatus 1-1 to 1-N from one another, each of the communication apparatus 1-1 to 1-N is referred to merely as communication apparatus 1. Furthermore, any communication apparatus 1 which functions as a client is referred to as client side communication apparatus 1, and any communication apparatus 1 which functions as a server is referred to as server side communication apparatus 1.

FIG. 2 shows an example of a hardware configuration of the communication apparatus 1.

Referring to FIG. 2, the communication apparatus 1 shown includes a central processing unit (CPU) 11 which executes various processes in accordance with a program stored in a ROM (Read Only Memory) 12 or a program loaded from a recording section 18 into a RAM (Random Access Memory) 13. Also data necessary for the CPU 11 to execute the processes are suitably stored into the RAM 13.

The CPU 11, ROM 12 and RAM 13 are connected to one another by a bus 14. Also an input/output interface 15 is connected to the bus 14.

An inputting section 16 including a keyboard, a mouse and so forth, an outputting section 17 including a speaker, a display unit which may be an LCD (Liquid Crystal Display) unit, and so forth, a recording section 18 formed from a hard disk or the like, and a communication section 19.

The communication section 19 is formed from, for example, a network interface card (NIC) or the like and controls a communication process with another block through the network 2. Details of the communication section 19 are hereinafter described.

Further, as occasion demands, a drive 20 is connected to the input/output interface 15. A removable medium 21 such as a magnetic disk, an optical disk, a magneto-optical disk, a semiconductor memory or the like is suitably loaded into the drive 20, and a computer program read from the loaded medium is installed into the recording section 18 as occasion demands.

It is to be noted that the hardware configuration of the communication apparatus 1 is not limited to that of the example of FIG. 2, but only may have at least a functional configuration hereinafter described with reference to FIG. 4, 11, 18 or 22.

FIG. 3 shows an example of a configuration of the hardware of the communication section 19.

Referring to FIG. 3, the communication section 19 is connected to the input/output interface 15 (FIG. 2) and transmits data supplied thereto from the CPU 11 (FIG. 2) to a different apparatus connected to the network 2 such as a different communication apparatus (the communication apparatus 1 in the example of FIG. 1) through the network 2. The communication section 19 further receives data transmitted thereto from a different apparatus connected to the network 2 through the network 2 and supplies the received data to the CPU 11. Further, the communication section 19 performs a protocol stack process (a predetermined process relating to a protocol stack), such as, for example, a TCP/IP (Transmission Control Protocol/Internet Protocol) process.

The communication section 19 includes a CPU 51, a ROM 52, a RAM 53, a recording section 55, an interface 56 and a transmission/reception processing section 57. The CPU 51, ROM 52, RAM 53, recording section 55, interface 56 and transmission/reception processing section 57 are connected to each other by a bus 54.

In the communication section 19 shown in FIG. 3, the CPU 51 executes various processes in accordance with a program stored in the ROM 52 or in accordance with a program loaded from the recording section 55 into the RAM 53.

The transmission/reception processing section 57 performs a predetermined process, for example, for transmitting data to a different apparatus through the network 2 or receiving data transmitted from a different apparatus connected to the network 2 under the control of the CPU 51.

It is to be noted that the hardware configuration of the communication section 19 is not limited that of the example of FIG. 3 but only may have at least a functional configuration hereinafter described with reference to FIG. 4, 11, 18 or 22.

An example of a functional configuration for implementing a function relating to a communication process with a different communication apparatus 1 through the network 2 from among functions of the communication apparatus 1 of the hardware configuration of FIGS. 2 and 3 is shown in FIG. 4. Referring to FIG. 4, in the example shown, the communication apparatus 1 includes a network application execution section 111, an interface section 112, a socket processing section 113, a protocol processing section 114, a real time control section 115, and a packet transmission section 116. The communication apparatus 1 further includes a packet reception section 117, a packet decision section 118, an RTP setting section 119, an RTP retaining section 120, and an RTP-client side port number conversion table retaining section 121.

In the example of FIG. 4, only the network application execution section 111 is provided outside the communication section 19 while the other components 112 to 121 are provided in the communication section 19.

In other words, in the example of FIG. 4, only the network application execution section 111 functions with application software (network application) under the control of an OS which is executed by the CPU 11 (FIG. 2). The other components 112 to 121 of the communication section 19 function under the control of the CPU 51 (FIG. 3).

It is to be noted that individual functions (operation) of the components 111 to 121 of the communication section 19 are not described here but are hereinafter described suitably in descriptions given with reference to FIGS. 5 to 10.

In the information processing system (FIG. 1) which includes the communication apparatus 1-1 to 1-N having the functional configuration described above with reference to FIG. 4, a function of setting an RTP to be used for communication is incorporated in the network application of the client side communication apparatus 1. The network application is executed by the network application execution section 111.

The RTP is an abbreviated word of real time parameter. The real time parameter represents a nature of the network 2 to be used for transmission or reception of data by the communication apparatus 1 on the client side at an end point (terminating device, in the present embodiment, the communication section 19 in FIGS. 2 and 3) of the network environment. The nature of the network 2 may be, for example, a priority degree, a used band, a permissible maximum latency or the like.

In this instance, in order to notify the server side of an RTP, the client side communication apparatus 1 converts the RTP into a transmission source port number in accordance with a conversion table (a particular example of which is hereinafter described with reference to FIG. 6) determined in advance. Then, the client side communication apparatus 1 uses the transmission source port number to notify the server side of the RTP. It is to be noted that such a conversion table as just mentioned is hereinafter referred to as RTP-client side port number conversion table. Further, the RTP-client side port number conversion table determined in advance signifies that, in the example of FIG. 4, the RTP-client side port number conversion table is retained in advance in the RTP-client side port number conversion table retaining section 121.

The server side communication apparatus 1 converts the transmission source port number conveyed from the client side into an RTP using the RTP-client side port number conversion table. In this instance, the RTP-client side port number conversion table is determined in advance also in the server side communication apparatus 1. In other words, the RTP-client side port number conversion table is retained in advance also in the RTP-client side port number conversion table retaining section 121 on the server side.

It is to be noted that, for the RTP, also an RTP of the server side itself designated from the network application can be used.

Since an RTP is described by both of the communication apparatus 1 of the client side and the server side, each of the communication apparatus 1 of the client side and the server side can perform real time control for data transmission and reception processes based on the RTP. Here, the real time control based on the RTP is, for example, priority control where the RTP is a parameter representative of a priority degree, but is, for example, band allocation control where the RTP is a parameter representative of a used band. Or, for example, where the RTP is a parameter representative of a maximum latency, the real time control is control for maximum latency assurance.

Several examples of processing by the client side or the server side for implementation of such operation of the information processing system are illustrated in FIGS. 5 to 10.

FIG. 5 illustrates an example of a series of processes (hereinafter referred to generally as client side RTP setting process) executed by the client side communication apparatus 1 (FIG. 4) until setting of an RTP is performed.

Referring to FIG. 5, at step S1, the network application executed by the network application execution section 111 (hereinafter referred to simply as “network application execution section 111) issues a socket generation request to the socket processing section 113 through the interface section 112.

At step S2, the socket processing section 113 generates a socket. The socket signifies, for example, in the present embodiment, a combination of an IP address and a port number. However, on the stage of the processing at step S2, the port number is not settled, but is settled (bound) by a process at step S5 hereinafter described.

At step S3, the network application execution section 111 designates (a type and a value of) an RTP to be used for communication to the RTP setting section 119 through the interface section 112.

At step S4, the RTP setting section 119 converts the designated RTP into a client side port number using the RTP-client side port number conversion table recorded in advance in the RTP-client side port number conversion table retaining section 121. Then, the RTP setting section 119 records the resulting port number and the RTP into the RTP retaining section 120.

More particularly, it is assumed here that, for example, the RTP-client side port number conversion table of the example of FIG. 6 is recorded in the RTP-client side port number conversion table retaining section 121. In particular, FIG. 6 illustrates the RTP-client side port number conversion table applied in a case wherein only a predetermined one of the three of the maximum latency, used band and priority degree is used as the type of the RTP.

In this instance, if the type of the RTP designated by the process at step S3 is the maximum latency, then if the RTP value is 1 ms, then the RTP is converted into a port number of 20,000 by the process at step S4. Then, the “maximum latency: 1 ms” and the “port number: 20,000” are recorded in a coordinated relationship with each other into the RTP retaining section 120.

It is to be noted that the number of types of the RTP to be used is not limited to one, but predetermined two or all of the three types of the maximum latency, used band and priority degree may be used as hereinafter described. In such an instance, though not shown, another RTP-client side port number conversion table may be adopted wherein a unique port number is allocated to and coordinated with each of all combinations of the types among values which can be taken by the types.

At step S5, the socket processing section 113 reads out the port number (in the particular example described above, 20,000) from the RTP retaining section 120 and binds the port number with the socket generated by the process at step S2.

The RTP setting process on the client side ends therewith.

FIG. 7 illustrates an example of a series of processes (hereinafter referred to generally as real time control process for client side data transmission) until the communication apparatus 1 (FIG. 4) of the client side performs real time control and transmits data to the network 2.

Referring to FIG. 7, the network application execution section 111 designates a socket and data of a transmission object (to be transmitted) and issues a transmission request to the socket processing section 113 through the interface section 112.

At step S12, the socket processing section 113 decides whether or not a client side port number is designated, that is, whether or not an RTP setting process is executed and an RTP is set already on the client side of FIG. 5.

If it is decided at step S12 that a client side port number is not designated, then the socket processing section 113 sets an ephemeral port number at step S13.

When an ephemeral port number is set by the process at step S13 or when it is decided that a client side port number is described by the process at step S12, the processing advances to step S14. At step S14, the socket processing section 113 notifies the protocol processing section 114 of the data designated by the process at step S11.

At step S15, the protocol processing section 114 performs, for example, in the present embodiment, a TCP UDP/IP packetization process as a process for signaling the data designated by the process at step S11, that is, the data received by the process at step S14, to the network 2. It is to be noted that the TCP UDP/IP signifies TCP/IP or UDP (User Datagram Protocol)/IP.

After the packet generated by the process at step S15 is provided from the protocol processing section 114 to the real time control section 115, the processing advances to step S16.

At step S16, the real time control section 115 performs real time control (for example, priority control, band allocation, maximum latency assurance or the like) based on the RTP recorded in the RTP retaining section 120.

It is to be noted that, in this instance, when an RTP is not set, that is, when an RTP is not recorded in the RTP retaining section 120, the real time control section 115 uses a default RTP to perform real time control.

After such real time control is performed and the packet is provided from the real time control section 115 to the packet transmission section 116, the processing advances to step S17.

At step S17, the packet transmission section 116 signals the packet to the network 2.

The real time control process for client side data transmission ends therewith.

Since the real time control section 115 can perform real time control for a packet to be signaled as described above, even during transmission of a large amount of data, data transmission which minimizes the delay of a command (hereinafter referred to as control command) for controlling a different device can be achieved.

FIG. 8 illustrates an example of a process of performing real time control for received data by the client side communication apparatus 1 (FIG. 4) The process just described is hereinafter referred to as real time control process for client side data reception.

At step S21, the packet reception section 117 receives a packet from the network 2.

When the packet is provided from the packet reception section 117 to the packet decision section 118, the processing advances to step S22.

At step S22, the packet decision section 118 checks the address and the port number of the packet header. Then, at step S23, the packet decision section 118 decides based on a result of the check whether or not the packet is destined for a process wherein the communication apparatus 1 itself behaviors as a client.

If it is decided at step S23 that the packet is not destined for the process wherein the communication apparatus 1 itself behaves as a client, or in other words, if the packet is destined for the process wherein the communication apparatus 1 itself behaves as a server, then a real time control process for server side data reception is executed at step S24. Then, the real time control process for client side data reception ends therewith. It is to be noted that the “real time control process for server side data reception” is, for example, in the present embodiment, processes at steps S35 to S41 hereinafter described with reference to FIG. 9.

In contrast, if it is decided at step S23 that the packet is destined for the process wherein the communication apparatus 1 itself behaves as a client, then the packet is provided from the packet decision section 118 to the real time control section 115. Thereafter, the processing advances to step S25.

At step S25, the CPU 11 performs real time control (for example, priority control, band allocation, maximum latency assurance or the like) based on the RTP recorded in the RTP retaining section 120.

It is to be noted that, in this instance, if an RTP is not set, that is, an RTP is not recorded in the RTP retaining section 120, then the real time control section 115 uses the default RTP to perform the real time control.

After such real time control is performed and the packet is provided from the real time control section 115 to the protocol processing section 114, the processing advances to step S26.

At step S26, the protocol processing section 114 performs, in the present embodiment, a process which uses the TCP UDP/IP as a protocol process of the packet received by the process at step S21.

At step S27, the protocol processing section 114 decides whether or not data exists in the packet.

If it is decided at step S27 that data exists in the packet, then the protocol processing section 114 extracts the data from the packet and provides the data to the network application execution section 111 through the socket processing section 113 and the interface section 112 at step S28.

When the process at step S28 comes to an end or when it is decided by the process at step S27 that data does not exist in the packet, the real time control process for client side data reception is ended.

As described above, the real time control section 115 can perform real time control also for a packet to be passed to the protocol processing section 114. Therefore, even during reception of a large amount of data, acceptance or execution of a control command is permitted.

Various examples of processing by the communication apparatus 1 of FIG. 4 on the client side are described above. Now, several examples of processing of the communication apparatus 1 on the server side are described.

For example, in the present embodiment, setting of an RTP by the communication apparatus 1 on the server side and real time control of a reception process are performed by the following process.

In particular, the server side communication apparatus 1 can execute, as a setting process of an RTP, a process of setting an RTP designated by a server side network application and a process of setting an RTP decided based on a transmission source port number (client side port number) of a packet transmitted from the client side.

In this instance, when the former process of setting an RTP is to be performed, the transmission and reception processes of data which involve real time control of the server side communication apparatus 1 are basically same as the real time control process for client side data transmission described hereinabove with reference to FIG. 7 and the real time control process for client side data reception described hereinabove with reference to FIG. 8, respectively.

On the other hand, when the latter process of setting an RTP is to be performed, for example, a process according to a flow chart of FIG. 9 is performed as the transmission and reception processes of data which involve real time control of the server side communication apparatus 1. It is to be noted, however, that the flow chart of FIG. 9 includes not only an example of the transmission and reception processes of data but also the latter process of setting an RTP, that is, an example of a process of setting an RTP decided based on a transmission source port number (client side port number) transmitted from the client side. Therefore, the process of FIG. 9 is hereinafter referred to as real time control process for RTP setting and data reception by the server side based on data from the client side.

Referring to FIG. 9, at step S31, the packet reception section 117 receives a packet from the network 2.

After the packet is provided from the packet reception section 117 to the packet decision section 118, the processing advances to step S32.

At step S32, the packet decision section 118 checks the address and the port number of the packet header. Then, at step S33, the packet decision section 118 decides based on a result of the check whether or not the packet is destined for a process wherein the communication apparatus 1 itself behaves as a server.

At step S33, if it is decided that the packet is not destined for a process wherein the communication apparatus 1 itself behaves as a server, that is, if it is decided that the packet is destined for a process wherein the communication apparatus 1 itself behaves as a client, the processing advances to step S34. At step S34, a real time control process for client side data reception is executed, and the real time control process for RTP setting and data reception by the server side based on the data from the client side ends therewith. It is to be noted that the “real time control process for client side data reception” at step S34 is, for example, in the present embodiment, the processes at steps S25 to S28 described hereinabove with reference to FIG. 8.

On the other hand, if it is decided at step S33 that the packet is destined for a process wherein the communication apparatus 1 itself behaves as a server, the processing advances to step S35.

At step S35, the packet decision section 118 decides from the transmission source address or the port number placed in the packet whether or not the opposite party of communication is a specific network communication apparatus.

Here, the specific network communication apparatus is a communication apparatus 1 in which the communication section 19 (end point) having the functional configuration described hereinabove with reference to FIG. 4 or a functional configuration hereinafter described with reference to FIG. 11, 18 or 22 is incorporated.

In particular, though not shown in FIG. 1, depending upon the form of the network 2, an apparatus in which an end point having a functional configuration different from the functional configuration described hereinabove with reference to FIG. 4 or a functional configuration hereinafter described with reference to FIG. 11, 18 or 22 is incorporated may be connected. In such an instance, the communication apparatus 1 can communicate with the apparatus as the opposite party of communication. However, when the apparatus mentioned is the opposite party of communication, it is decided at step S35 that the opposite party of communication is not the specific network communication apparatus. In this instance, a process at step S37 hereinafter described is not executed, but the packet is supplied from the packet decision section 118 to the real time control section 115. Thus, the processing advances to step S38.

On the other hand, if it is decided at step S35 that the opposite party of communication is a specific network communication apparatus, then the packet decision section 118 further decides at step S36 whether or not decision of an RTP has been made formerly.

If it is decided at step S36 that decision of an RTP has been made formerly, then a process at step S37 hereinafter described is not executed, but the packet is provided from the packet decision section 118 to the real time control section 115. Then, the processing advances to step S38.

On the other hand, if it is decided at step S36 that decision of an RTP has not been made formerly, then the processing advances to step S37. At step S37, the packet decision section 118 uses the RTP-client side port number conversion table recorded in advance in the RTP-client side port number conversion table retaining section 121 to decide an RTP from the transmission source port number (client side port number). Then, the packet decision section 118 records the RTP into the RTP retaining section 120. Then, the packet is provided from the packet decision section 118 to the real time control section 115, and then, the processing advances to step S38.

At step S38, the real time control section 115 performs real time control (for example, priority control, band allocation, maximum latency assurance or the like) based on the RTP recorded in the RTP retaining section 120.

It is to be noted that, in this instance, if an RTP is not set, that is, if an RTP is not recorded in the RTP retaining section 120, then the real time control section 115 performs real time control using the default RTP.

When such real time control is performed and the packet is provided from the real time control section 115 to the protocol processing section 114, the processing advances to step S39.

At step S39, the protocol processing section 114 performs a process of using, for example, in the present embodiment, the TCP UDP/IP as a protocol process of the packet received by the process at step S31.

At step S40, the protocol processing section 114 decides whether or not data exists in the packet.

If it is decided at step S40 that data exists in the packet, then the protocol processing section 114 extracts, at step S41, the data from the packet and provides the data to the network application execution section 111 through the socket processing section 113 and the interface section 112.

After the process at step S41 ends or when it is decided by the process at step S40 that data does not exist in the packet, the real time control process for RTP setting and data reception on the server side based on the data from the client side ends.

Now, an example of a series of processes (hereinafter referred to as real time control process for server side data transmission) until the server side communication apparatus 1 (FIG. 4) performs real time control and transmits data to the network 2 is described with reference to a flow chart of FIG. 10.

At step S51, the network application execution section 111 issues a transmission request designating a socket and data of a transmission object (to be transmitted) to the socket processing section 113 through the interface section 112.

At step S52, the socket processing section 113 notifies the protocol processing section 114 of the data designated by the process at step S51.

At step S53, the protocol processing section 114 performs a packetization process of, for example, in the present embodiment, the TCP UDP/IP as a process for signaling the data designated by the process at step S51 (data designated in the notification issued by the process at step S52) to generate a packet.

When the packet generated by the process at step S53 is provided from the protocol processing section 114 to the real time control section 115, the processing advances to step S54.

At step S54, the real time control section 115 performs real time control (for example, priority control, band allocation, maximum latency assurance or the like) based on the RTP recorded in the RTP retaining section 120.

It is to be noted that, in this instance, if an RTP is not set as yet, that is, if an RTP is not recorded in the RTP retaining section 120, then the real time control section 115 uses the default RTP to perform real time control.

More particularly, a case is assumed wherein data transmission by communication A which has RTPs of a band of 512 Kbps, a maximum latency of 1 msec and a priority degree of 1 and data transmission by communication B which has RTPs of a band of 500 MB, a maximum latency 10 msec and a priority degree of 2 are being performed simultaneously. In this instance, if the bands or the maximum latencies of both of the communication A and the communication B may not be assured simultaneously, then the real time control section 115 can perform such real time control as to assure resources preferentially for the communication A which has the RTP having a higher priority degree, cause the transmission of the communication A to be performed with the assured resources and then cause the transmission of the communication B to be performed with the remaining sources.

When such real time control is performed and the packet is provided from the real time control section 115 to the packet transmission section 116, the processing advances to step S55.

At step S55, the packet transmission section 116 signals the packet to the network 2.

The real time control process for server side data transmission ends therewith.

The communication apparatus 1 having the functional configuration described hereinabove with reference to FIG. 4 is described above as an embodiment of the communication apparatus 1 to which the present invention is applied. However, the functional configuration of the communication apparatus 1 is not limited to that of the example of FIG. 1, but the communication apparatus 1 may have various forms.

In particular, functional block diagrams of other forms of the communication apparatus 1 are shown, for example, in FIGS. 11, 18 and 22.

Referring first to FIG. 11, the communication apparatus 1 shown is a modification to but is different from that of the configuration described hereinabove with reference to FIG. 4 in that it does not include the RTP-client side port number conversion table retaining section 121 but additionally includes an opposite party decision section 131 and an RTP decision section 132 instead.

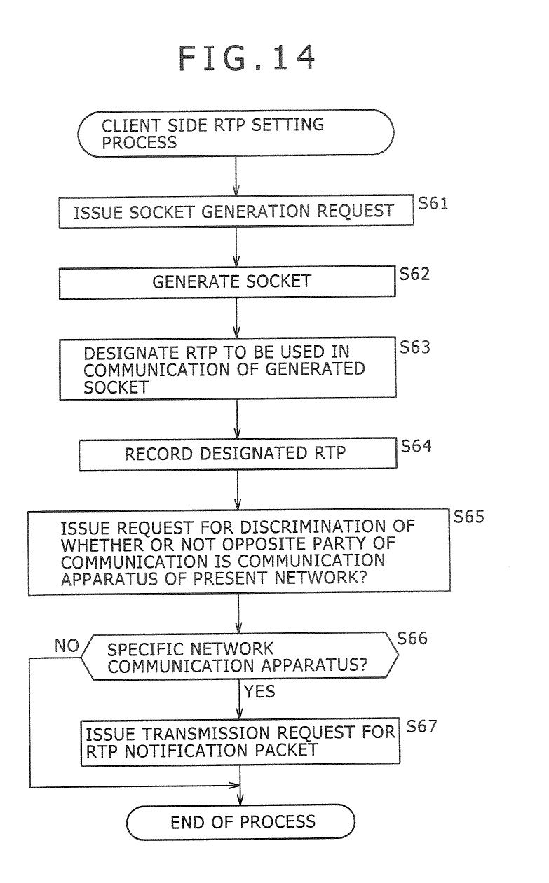

It is to be noted that description of individual functions (operations) of the opposite party decision section 131 and the RTP decision section 132 is omitted here but is suitably included in the description hereinafter given with reference to FIGS. 14 to 17.

In the information processing system (FIG. 1) which includes the communication apparatus 1-1 to 1-N having the functional configuration of the example of FIG. 11, the client side communication apparatus 1 does not use a client side port number in the notification as in the example of FIG. 4 described hereinabove in order to notify the server side communication apparatus 1 of an RTP. Instead, the client side communication apparatus 1 generates a special packet (hereinafter referred to as RTP notification packet) for the notification of an RTP and transmits the RTP notification packet to the server side to notify the server side of an RTP.

FIGS. 12 and 13 illustrate an example of a format of the RTP notification packet for which the TCP is used and an example of a formation of an RTP notification packet for which the UDP is used, respectively. The RTP notification packet of the example of FIG. 12 includes description regions for an IP header, a TCP header and data in order from the top thereof. Meanwhile, the RTP notification packet of the example of FIG. 13 includes description regions for an IP header, a UDP header and data in order from the top thereof. It is to be noted that, in both of the examples of FIGS. 12 and 13, the description region for data includes description regions for a transmission source IP address, a transmission source port number, a destination IP address, a destination port number, and a maximum latency, a band and a priority degree as RTPs.

From the foregoing, the process relating to an RTP notification packet from among the processes of the communication apparatus 1 of the example of FIG. 11 (processes by the client side and the server side) is different from that of the example of FIG. 4. In other words, except this, the processes by both of the server side and the client side are similar to those in the case of the example of FIG. 4 described hereinabove. Further, also in the case of the example of FIG. 11, for an RTP on the server side, an RTP designated from the network application of the server side itself may be used or an RTP designated by a notification by an RTP notification packet received from the client side may be used similarly as in the case of the example of FIG. 4.

Now, several examples of processing relating to an RTP notification packet are described with reference to FIGS. 14 to 17.

FIG. 14 is a flow chart illustrating an example of a client side RTP setting process by the client side communication apparatus 1 having the functional configuration of FIG. 11.

Referring to FIG. 14, at step S61, the network application execution section 111 issues a socket generation request to the socket processing section 113 through the interface section 112.

At step S62, the socket processing section 113 generates a socket.

At step S63, the network application execution section 111 designates an RTP to be used in communication of the generated socket to the RTP setting section 119 through the interface section 112. In particular, for example, where the RTP notification packet described hereinabove with reference to FIG. 12 or 13 is adopted, a value of the maximum latency, a value of the band and a value of the priority degree are designated as RTPs.

At step S64, the RTP setting section 119 records the designated RTPs into the RTP retaining section 120.

At step S65, the RTP setting section 119 issues a decision request to the opposite party decision section 131 to decide whether or not the opposite party of communication is a specific network communication apparatus.

At step S66, the opposite party decision section 131 decides, for example, based on the destination address whether or not the opposite party of communication is a specific network communication apparatus.

If it is decided at step S66 that the opposite party of communication is a specific network communication apparatus, then the opposite party decision section 131 issues a transmission request of an RTP notification packet to the socket processing section 113 at step S67. For the transmission source port number in this instance, a specific port number representing that the pertaining packet is an RTP notification packet (which is different from the client side port number placed in the data in the RTP notification packet) is adopted. The RTP setting process by the client side ends therewith.

In this instance, the real time control process for client side data transmission described hereinabove with reference to FIG. 7 is executed, and an RTP notification packet is generated and signaled to the network 2. In other words, the process at step S67 is executed in place of the process at step S11 of FIG. 7, and thereafter, the processes at step S12 et seg. are executed.

On the other hand, if it is decided at step S66 that the opposite party of communication is not a specific network communication apparatus, then the process at step S67 is not executed, and hence an RTP notification packet is not signaled to the opposite party of communication. Then, the RTP notification packet by the client side ends therewith.

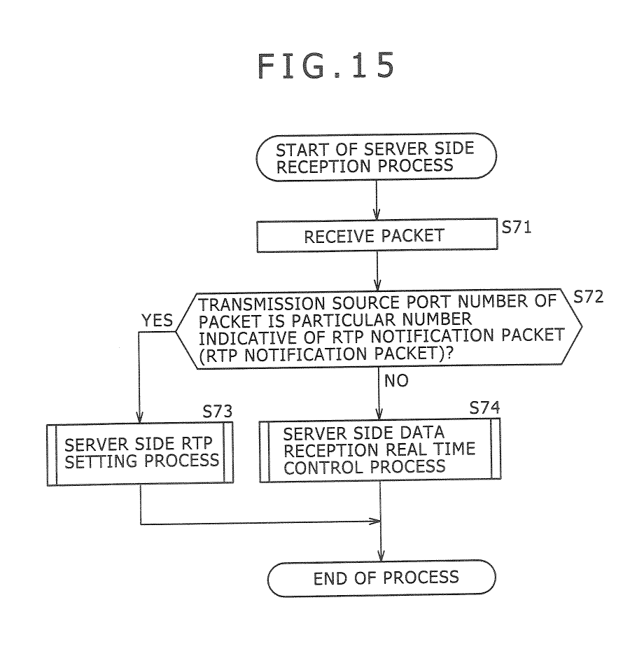

FIG. 15 illustrates an example of a process executed by the server side communication apparatus 1 (FIG. 11) when a packet is received (the process is hereinafter referred to as server side reception process).

Referring to FIG. 15, first at step S71, the packet reception section 117 receives a packet from the network 2.

The packet is provided from the packet reception section 117 to the packet decision section 118, and the processing advances to step S72.

At step S72, the packet decision section 118 decides whether or not the transmission source port number of the packet is the specific number indicative of the RTP notification packet. In other words, the packet decision section 118 decides whether or not the packet received by the process at step S71 is an RTP notification packet.

If it is decided at step S72 that the received packet is an RTP notification packet, then a server side RTP setting process hereinafter described with reference to FIG. 16 is executed at step S73.

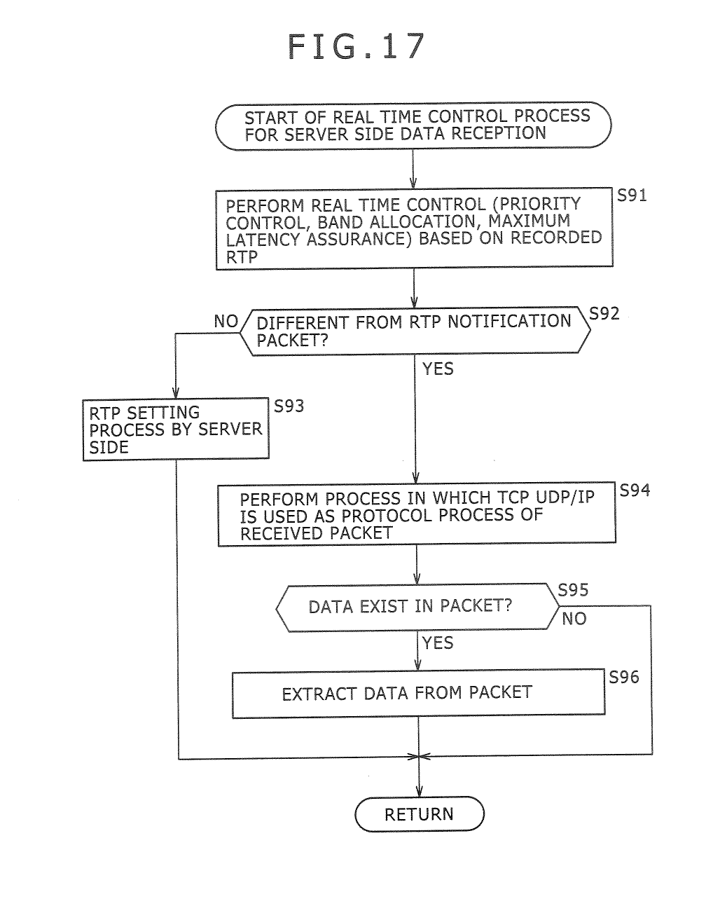

On the other hand, if it is decided at step S72 that the received packet is not an RTP notification packet, then a real time control process for server side data reception hereinafter described with reference to FIG. 17 is executed at step S74.

When the server side RTP setting process at step S73 or the real time control process for server side data reception at step S74 ends, the server side reception process ends.

FIG. 16 illustrates an example of details of the server side RTP setting process at step S73.

If it is decided at step S72 of FIG. 15 that the packet is an RTP notification packet as described hereinabove, then the packet received by the process at step S71 of FIG. 15 is provided from the packet decision section 118 to the real time control section 115. Then, the server side RTP setting process is started.

Referring to FIG. 16, at step S81, the real time control section 115 performs real time control (for example, priority control, band allocation, maximum latency assurance or the like) based on the RTP regarding the RTP notification packet recorded in advance in the RTP retaining section 120.

It is to be noted that, in this instance, if an RTP is not set, that is, if an RTP is not recorded in the RTP retaining section 120, then the real time control section 115 executes real time control using the default RTP.

After such real time control is performed and the packet is provided from the real time control section 115 to the protocol processing section 114, the processing advances to step S82.

At step S82, the protocol processing section 114 extracts data from the packet and checks the transmission source port number of the packet. Then at step S83, the protocol processing section 114 decides based on a result of the check whether or not the transmission source port number of the packet is a specific number indicative of an RTP notification packet. In other words, the protocol processing section 114 decides whether or not the packet received by the process at step S71 is an RTP notification packet.

If it is decided at step S83 that the received packet is not an RTP notification packet, then the protocol processing section 114 executes a normal packet reception process at step S84. The normal packet reception process here signifies, for example, processes at steps S94 to S96 hereinafter described with reference to FIG. 17. The server side RTP setting process at step S73 of FIG. 15 ends therewith, and also the server side reception process ends.

On the other hand, if it is decided at step S83 that the packet is an RTP notification packet, then the protocol processing section 114 extracts the data placed in the packet and provides the data to the RTP decision section 132 at step S85.

Then at step S86, the RTP decision section 132 records an RTP placed in the data extracted by the process at step S85 (in the example of FIG. 12 or 13, a described value in any of the regions for the maximum latency, band allocation and priority degree) into the RTP retaining section 120. The RTP decision section 132 further records a client side port number and an address also placed in the data (in the example of FIG. 12 or 13, a described value in any of the regions for the transmission source IP address and the transmission source port number) into the RTP retaining section 120. The server side RTP setting process at step S73 of FIG. 15 ends therewith. Also the server side reception process ends.

It is to be noted that it is naturally possible to adopt, as the server side RTP setting process at step S73 of FIG. 15, a process of setting an RTP designated by the server side network application in place of the process described hereinabove with reference to the flow chart of FIG. 16.

Now, an example of details of the real time control process for server side data reception at step S74 of FIG. 15 is described with reference to FIG. 17.

As described hereinabove, if it is decided at step S72 of FIG. 15 that the received packet is not an RTP notification packet, then the packet received by the process at step S71 of FIG. 15 is provided from the packet decision section 118 to the real time control section 115. As a result, the real time control process for server side data reception is started.

In particular, at step S91, the real time control section 115 performs real time control (for example, priority control, band allocation, maximum latency assurance or the like) based on the RTP recorded in the RTP retaining section 120.

It is to be noted that, in this instance, if an RTP is not set, that is, if an RTP is not recorded in the RTP retaining section 120, then the real time control section 115 uses the default RTP to perform real time control.

After such real time control is performed and the packet is provided from the real time control section 115 to the protocol processing section 114, the processing advances to step S92.

At step S92, the protocol processing section 114 decides whether or not the packet provided thereto (the packet received by the process at step S71) is different from an RTP notification packet.

If the received packet is not different from an RTP notification packet, then the protocol processing section 114 executes a server side RTP setting process at step S93. The server side RTP setting process here signifies the processes at step S85 and S86 described hereinabove with reference to FIG. 16.

On the other hand, if it is decided at step S92 that the received packet is different from an RTP notification packet, then the protocol processing section 114 performs, at step S94, for example, a process in which the TCP UDP/IP is used as a protocol process for the packet received by the process at step S71 of FIG. 15.

At step S95, the protocol processing section 114 decides whether or not data exists in the packet.

If it is decided at step S95 that data exists in the packet, then the protocol processing section 114 extracts the data from the packet and supplies the data to the network application execution section 111 through the socket processing section 113 and the interface section 112 at step S96.

After the process at step S96 ends or it is decided by the process at step S95 that data does not exist in the packet, the real time control process for server side data reception at step S74 of FIG. 15 ends. Consequently, also the server side reception process ends.

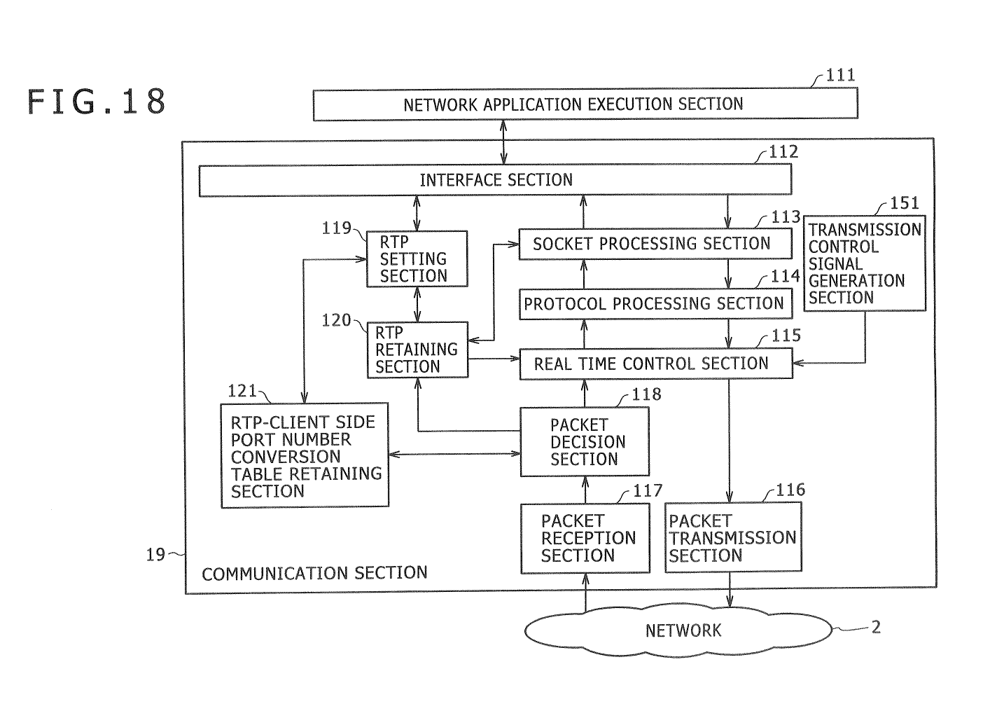

A functional block diagram of the communication apparatus 1 having a different functional configuration from those of the examples described hereinabove with reference to FIGS. 4 and 11 is shown in FIG. 18.

The communication apparatus 1 of the example of FIG. 18 is a modification to but is different from the communication apparatus 1 having the configuration described hereinabove with reference to FIG. 4 in that it additionally includes a transmission control signal generation section 151.

Consequently, a process of transmitting data having a particular RTP value can be executed at an output timing of a signal (hereinafter referred to suitably as external signal) generated by the transmission control signal generation section 151 (the process mentioned is hereinafter referred to as data transmission process by transmission timing control).

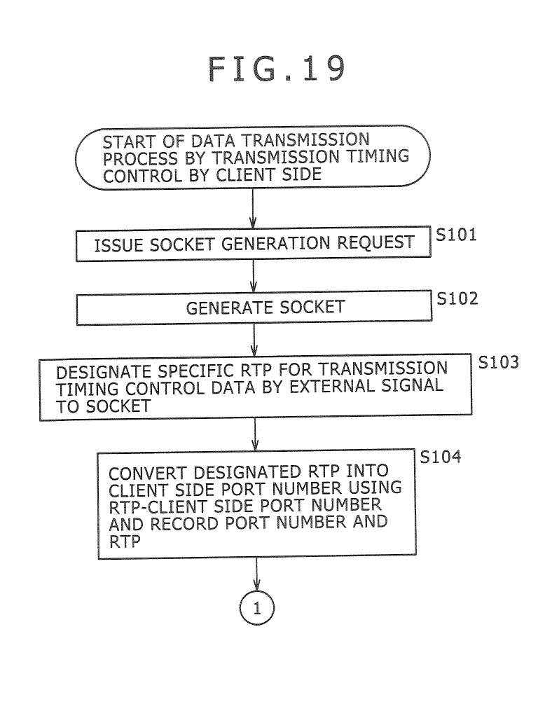

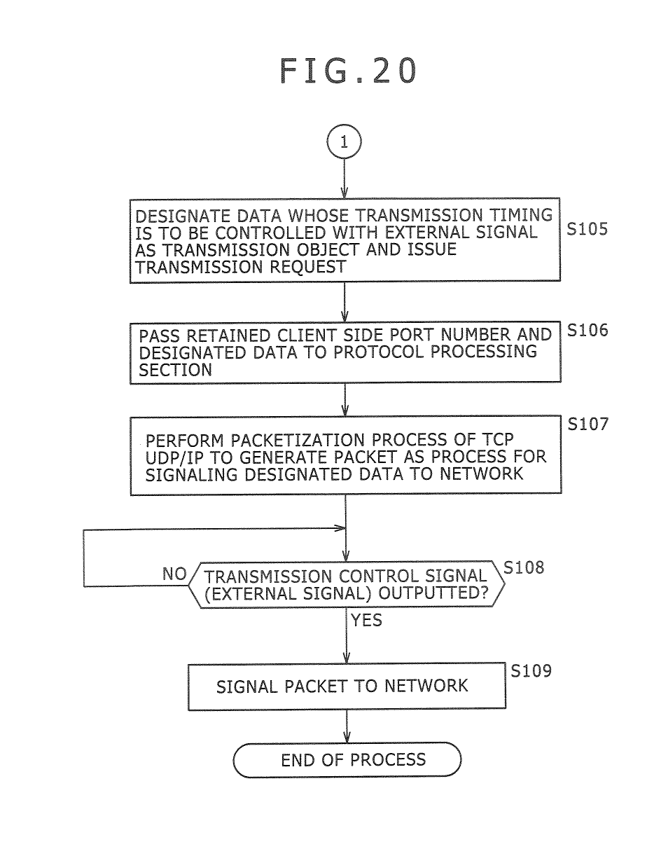

An example of the data transmission process by transmission timing control on the client side is illustrated, for example, in flow charts of FIGS. 19 and 20.

Referring first to FIG. 19, at step S101, the network application execution section 111 issues a socket generation request to the socket processing section 113 through the interface section 112.

At step S102, the socket processing section 113 generates a socket.

At step S103, the network application execution section 111 designates a particular RTP for transmission timing control data by an external signal to the socket and issues a notification of the designation to the RTP setting section 119 through the interface section 112.

At step S104, the RTP setting section 119 uses the RTP-client side port number conversion table to convert the designated RTP into a port number of the client side to be used for communication. Then, the RTP setting section 119 records the port number and the RTP in a coordinated relationship with each other into the RTP retaining section 120.

After such RTP setting is performed by the processes at steps S101 to S104, the processing advances to step S105 of FIG. 20.

Referring now to FIG. 20, at step S105, the network application execution section 111 designates data whose transmission timing is to be controlled with an external signal as a transmission object and issues a transmission request of the designated transmission object to the socket processing section 113 through the interface section 112.

At step S106, the socket processing section 113 passes the client side port number retained in the RTP retaining section 120 and the data designated by the process at step S105 to the protocol processing section 114.

At step S107, the protocol processing section 114 performs a packetization process, for example, of the TCP UDP/IP to generate a packet as a process for signaling the designated data to the network 2.

After the packet generated by the process at step S107 is provided from the protocol processing section 114 to the real time control section 115, the processing advances to step S108.

At step S108, the real time control section 115 decides whether or not a transmission control signal (external signal) is outputted from the transmission control signal generation section 151.

If it is decided at step S108 that a transmission control signal (external signal) is not outputted, then the processing is returned to step S108, at which it is decided again whether or not a transmission control signal (external signal) is outputted.

In other words, the loop process at step S108 is repeated to block transmission of the data until a transmission control signal (external signal) is outputted.

Since the transmission control signal generation section 151 outputs a transmission control signal in a predetermined period to the real time control section 115, when a transmission control signal is outputted in a next period, then a decision of YES is made immediately at step S108. Consequently, the packet is provided from the real time control section 115 to the packet transmission section 116. As a result, the processing advances to step S109.

At step S109, the packet transmission section 116 signals the packet to the network 2.

The data transmission process by transmission timing control on the client side ends therewith.

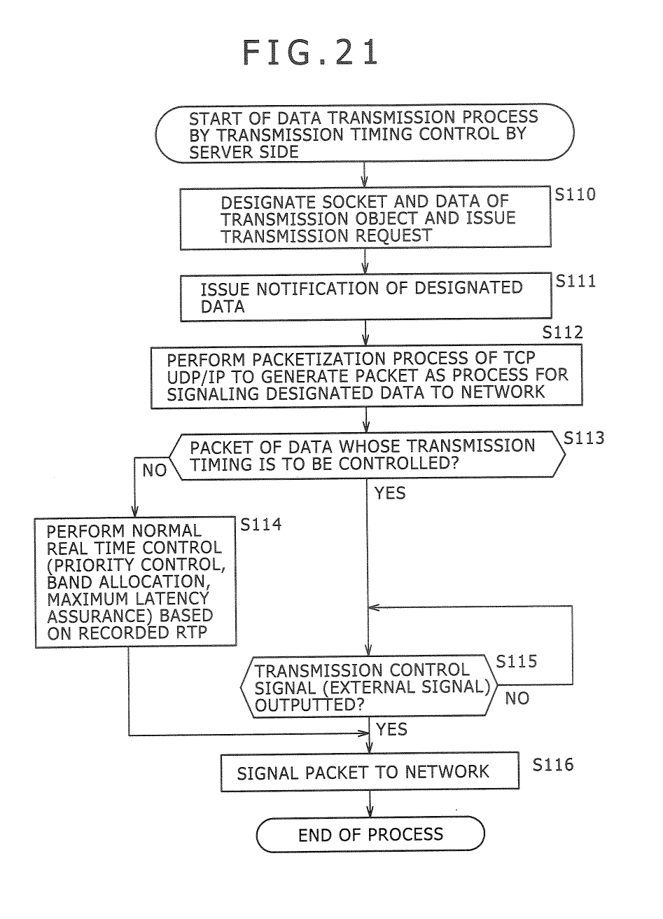

In contrast to such a data transmission process by transmission timing control on the client side as described above, an example of a data transmission process by transmission timing control on the server side is illustrated in FIG. 21.

Referring to FIG. 21, at step S110, the network application execution section 111 designates a socket and data of a transmission object and issues a transmission request to the socket processing section 113 through the interface section 112.

At step S111, the socket processing section 113 notifies the protocol processing section 114 of the designated data.

At step S112, the protocol processing section 114 performs a packetization process, for example, of the TCP UDP/IP to generate a packet as a process for signaling the designated data to the network 2.

After the packet generated by the process at step S112 is provided from the protocol processing section 114 to the real time control section 115, the processing advances to step S113.

At step S113, the real time control section 115 checks the RTP recorded in the RTP retaining section 120 and decides based on a result of the check whether or not the packet is for data for controlling the transmission timing.

If it is decided at step S113 that the packet is not for data for controlling the transmission timing, that is, the packet is not for the transmission timing control data, or if an RTP itself is not set, then the processing advances to step S114. At step S114, the real time control section 115 performs real time control (for example, priority control, band allocation, maximum latency assurance or the like) based on the RTP.

It is to be noted that, in this instance, if an RTP is not set, that is, if an RTP is not recorded in the RTP retaining section 120, then the real time control section 115 uses the default RTP to perform real time control.

After such real time control is preformed and the packet is provided from the real time control section 115 to the packet transmission section 116, the processing advances to step S116.

At step S116, the packet transmission section 116 signals the packet to the network 2. The data transmission process by transmission timing control on the server side ends therewith.

On the other hand, if it is decided at step S113 that the RTP is for data for controlling the transmission timing, that is, the RTP is for the transmission timing control data, then the processing advances to step S115. At step S115, the real time control section 115 decides whether or not a transmission control signal (external signal) is outputted from the transmission control signal generation section 151.

If it is decided at step S115 that a transmission control signal (external signal) is not outputted, then the processing returns to step S115, at which it is decided again whether or not a transmission control signal (external signal) is outputted.

In other words, the loop process at step S115 is repeated to block transmission of the data until a transmission control signal (external signal) is outputted.

Since the transmission control signal generation section 151 outputs a transmission control signal in a predetermined period to the real time control section 115, when a transmission control signal is outputted in a next period, a decision of YES is made immediately at step S115. Consequently, the packet is provided from the real time control section 115 to the packet transmission section 116. As a result, the processing advances to step S116.

At step S116, the packet transmission section 116 signals the packet to the network 2. The data transmission process by transmission timing control on the server side ends therewith.

As described above, the communication apparatus 1 executes its processing in accordance with the flow charts of FIGS. 19 and 20 where it operates as a client side communication apparatus. However, where the communication apparatus 1 operates as a server side communication apparatus, it executes its processing in accordance with the flow chart of FIG. 21. In any case, the communication apparatus 1 can successively transmit data at each generation timing of a transmission control signal (external signal).

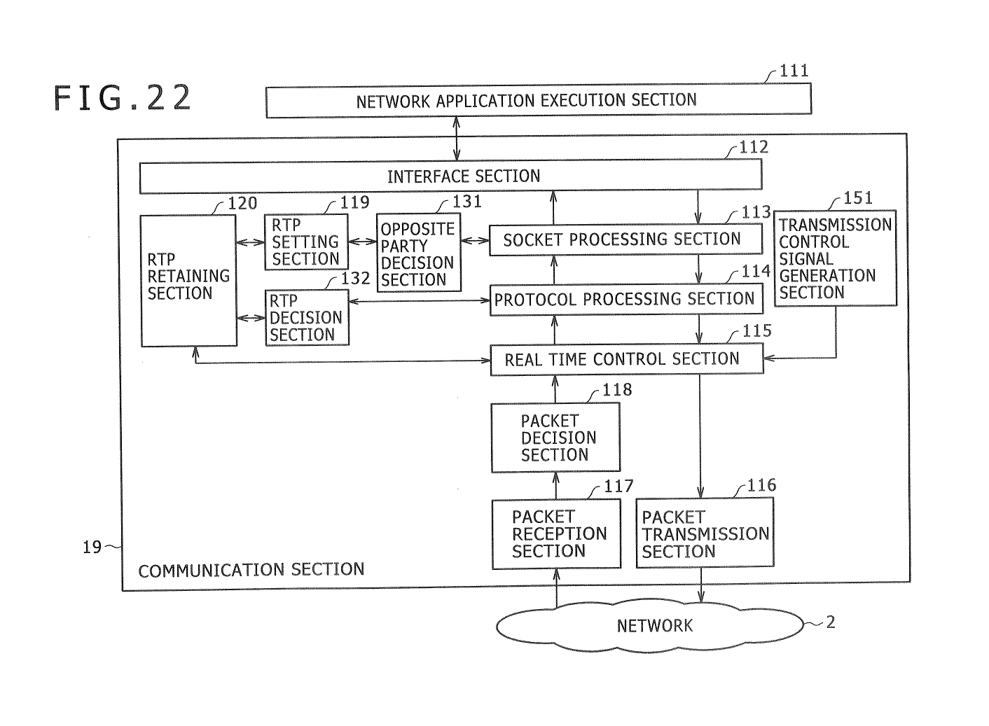

A functional block diagram of the communication apparatus 1 having a different functional configuration from those of the examples described hereinabove with reference to FIGS. 4, 11 and 18 is shown in FIG. 22.

The communication apparatus 1 of the example of FIG. 22 is a modification to but is different from the communication apparatus 1 of the configuration of the example of FIG. 11 in that it additionally includes a transmission control signal generation section 151 similar to that in the example of FIG. 18.

Consequently, also with the communication apparatus 1 of the example of FIG. 22, execution of a data transmission process by transmission timing control can be achieved.

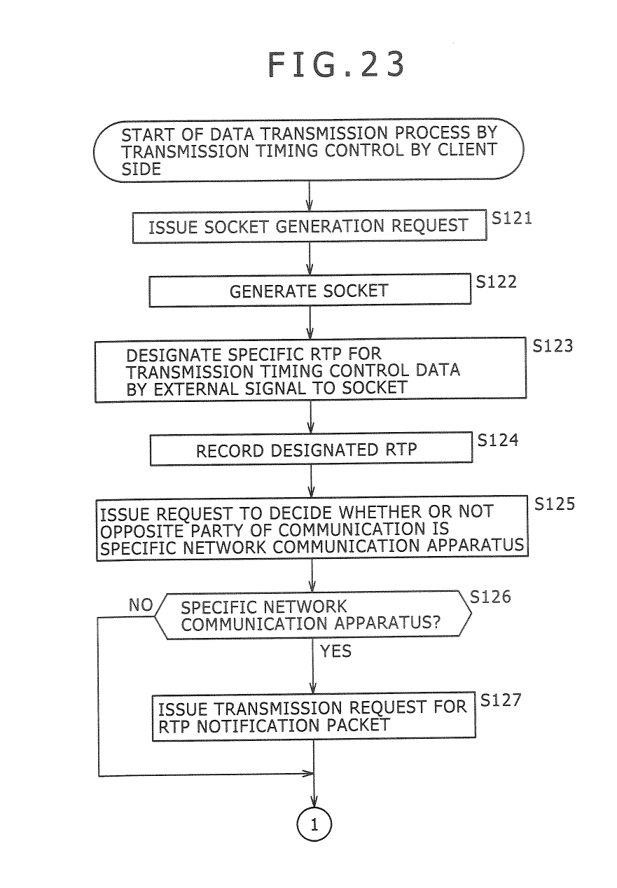

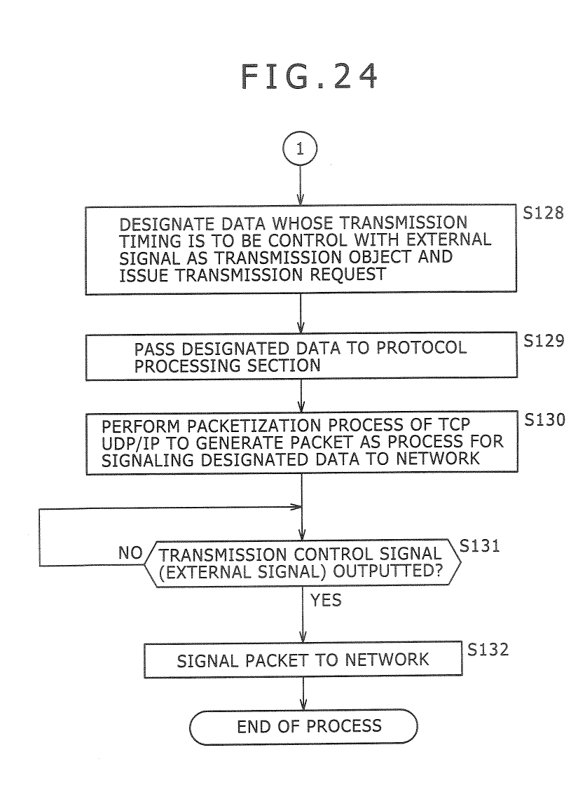

An example of a data transmission process by transmission timing control on the client side where the communication apparatus 1 of the example of FIG. 22 serves as a client side communication apparatus is illustrated, for example, in flow charts of FIGS. 23 and 24.

Referring first to FIG. 23, at step S121, the network application execution section 111 issues a socket generation request to the socket processing section 113 through the interface section 112.

At step S122, the socket processing section 113 generates a socket.

At step S123, the network application execution section 111 designates a particular RTP for transmission timing control data by an external signal to the socket and issues a notification of the designation to the RTP setting section 119 through the interface section 112.

At step S124, the RTP setting section 119 records the designated RTP into the RTP retaining section 120.

At step S125, the RTP setting section 119 issues a request to the opposite party decision section 131 to decide whether or not the opposite party of communication is a specific network communication apparatus.

At step S126, the opposite party decision section 131 decides, for example, based on the destination address, whether or not the opposite party of communication is a specific network communication apparatus.

If it is decided at step S126 that the opposite party of communication is a specific network communication apparatus, then the opposite party decision section 131 issues a transmission request for an RTP notification packet to the socket processing section 113 at step S127. The transmission source port number to be used in this instance is a particular port number indicative of an RTP notification packet (different from the client side port number placed in the data in the RTP notification packet).

In this instance, though not shown in FIG. 23, an RTP notification packet is generated and signaled to the network 2. In other words, the process at step S127 is executed in place of the process at step S11 of FIG. 7, and thereafter, the processes at step S12 et seq. are executed. RTP setting is performed thereby.

On the other hand, if it is decided at step S126 that the opposite party of communication is not a specific network communication apparatus, then the process at step S127 is not executed, and consequently, an RTP notification packet is not signaled to the opposite party of communication. Then, the RTP setting itself ends.

After the RTP setting is performed in this manner, the processing advances to step S128 of FIG. 24.

Referring now to FIG. 24, at step S128, the network application execution section 111 designates data whose transmission timing is to be controlled with an external signal as a transmission object and issues a transmission request for the transmission object to the socket processing section 113 through the interface section 112.

At step S129, the socket processing section 113 passes the data designated by the process at step S128 to the protocol processing section 114.

At step S130, the protocol processing section 114 performs a packetization process, for example, of the TCP UDP/IP to generate a packet as a process for signaling the designated data to the network 2.

After the packet generated by the process at step S130 is provided from the protocol processing section 114 to the real time control section 115, the processing advances to step S131.

At step S131, the real time control section 115 decides whether or not a transmission control signal (external signal) is outputted from the transmission control signal generation section 151.

If it is decided at step S131 that a transmission control signal (external signal) is not outputted, then the processing is returned to step S131, at which it is decided again whether or not a transmission control signal (external signal) is outputted.

In other words, the loop process at step S131 is repeated to block transmission of data until a transmission control signal (external signal) is outputted.

Since the transmission control signal generation section 151 outputs a transmission control signal in a predetermined period to the real time control section 115, when a transmission control signal is outputted in a next period, then a decision of YES is made immediately at step S131. Consequently, the packet is provided from the real time control section 115 to the packet transmission section 116. As a result, the processing advances to step S132.

At step S132, the packet transmission section 116 signals the packet to the network 2.

The data transmission process by transmission timing control on the client side ends therewith.

It is to be noted that the data transmission process by transmission timing control on the server side where the communication apparatus 1 in the example of FIG. 22 serves as a server side communication apparatus is basically similar to the process described hereinabove with reference to FIG. 21. Therefore, overlapping description of the data transmission process mentioned is omitted herein to avoid redundancy.

As described above, the communication apparatus 1 to which the present invention is applied makes it possible to designate, at an end point of a network environment such as the Ethernet (registered trademark), an RTP which represents a nature of the network such as, for example, a priority degree, a used band or a permissible maximum latency and which the user wants to use in transmission and reception of data. Consequently, a data transmission and reception process can be controlled in accordance with the RTP. Accordingly, even during high-speed transmission and reception of a large amount of data, transmission and reception of data whose delay or jitters should be minimized can be achieved.

Consequently, even while a large amount of data such as AV (Audio and Visual) data is being received at a high speed, it is possible to accept and execute a control command without delay. Further, even while a large amount of data such as AV data is being transmitted at a high speed, a control command can be transmitted without delay.

Further, where the opposite party (server side) is notified of an RTP, if the opposite party is a specific network communication apparatus (apparatus which incorporates the communication section 19 which has the functional configuration described hereinabove with reference to FIG. 4 or the like), even if the opposite party is receiving a large amount of data such as AV data at a high speed, it is possible to send a control command to the other party without delay so as to be executed by the other party. Also while the opposite party is transmitting a large amount of data such as AV data at a high speed, a control command from the opposite party can be received and executed without delay.

In particular, for example, a case is examined wherein FTP (File Transfer Protocol) transfer of an AV file and apparatus control by a 9Pin command are performed simultaneously between two communication apparatus 1 to which the present invention is applied using a single Ethernet (registered trademark) cable.

In this instance, it is assumed that RTPs for communication are set in the following manner in the client side communication apparatus 1 which issues a request for communication:

RTP for FTP transfer . . . band: 200 Mbps, maximum latency: 50 msec, priority degree: 2

RTP for 9Pin command . . . band: 512 Kbps, maximum latency: 1 msec, priority degree: 1

It is to be noted that the RTP here does not have a value through the entire network 2 but has a value in the client side communication apparatus 1.

The processing in this instance is executed, for example, as processes at steps S201 to S207 described below.

At step S201, FTP communication is started in response to a user operation on the client side communication apparatus 1.

At step S202, the network application of the client side communication apparatus 1 (network application execution section 111 shown in FIG. 4 and so forth) designates the RTP for FTP transfer mentioned hereinabove to the communication section 19 (FIG. 4 and so forth) on the client side.

At step S203, the communication section 19 on the client side makes use of the technique which uses a port number is used (refer to FIGS. 5 to 7 and so forth) or the technique which uses the RTP notification packet (refer to FIG. 14 and so forth) to notify the communication apparatus 1 of an RTP to be used.

At step S204, the communication section 19 assures the band and the maximum latency set by the process at step S202 to perform transmission or reception of a packet for FTP communication.

Similarly, if the user performs some operation on the client side communication apparatus 1 so as to issue a 9Pin command to the opposite party of communication, then the network application of the client side designates the RTP for the 9Pin command described above to the communication section 19.

At step S206, the communication section 19 assures the band and the maximum latency set by the process at step S205 to perform transmission or reception of the packet for the 9Pin command.

It is to be noted that the processes at steps S201 to S204 and the processes at steps S205 and S206 are independent of each other and the processing order of them is not limited to that described above. In other words, the former processes and the latter processes may be executed in an arbitrary order including simultaneous execution.

In this instance, even if command communication is performed, for example, during FTP transfer of an AV file of a large size, the maximum latency of 1 msec is assured for the packet for the 9Pin command by the processes at steps S201 to S204 and the processes at steps S205 and S206. Therefore, the 9Pin command can be transmitted and received without delay, and consequently, the command can be executed/caused to be executed.

Further, for example, where the number of channels in FTP communication or 9Pin command communication increases until it may not assure the designated band or the maximum latency, it is possible to assure the band or the maximum latency beginning with an RTP having a higher priority degree (having a lower priority degree value).

On the other hand, at step S207, the communication section 19 uses the RTP value conveyed from the client side by the process at step S203 or the RTP value designated by the server side network application (network application execution section 111 of the server side communication apparatus 1 itself) to perform transmission and reception of packets while assuring the band and the maximum latency of each of the FTP and 9Pin command packets similarly as on the client side.

By such a process at step S207 as just described, for example, even when command communication is performed during FTP transfer of an AV file of a large size, since the maximum latency of 1 msec is assured for the 9Pin command packet, transmission and reception of the 9Pin command can be performed without delay. Consequently, the command can be executed/caused to be executed.

Incidentally, while the series of processes described above (or some of the processes) can be executed by hardware, it may otherwise be executed by software.

Where the series of processes is executed by software, a program which constructs the software is installed from a network or a recording medium into a computer incorporated in hardware for exclusive use or, for example, a personal computer for universal use which can execute various functions by installing various programs.

The recording medium may be formed as a removable medium (package medium) 21 such as, as shown in FIG. 2 or 3, a magnetic disk (including a floppy disk), an optical disk (including a CD-ROM (Compact Disc-Read Only Memory) and a DVD (Digital Versatile Disk)), a magneto-optical disk (including an MD (Mini-Disk)), or a semiconductor memory which has the program recorded thereon or therein and is distributed in order to provide the program to a user separately from an apparatus body, or as the ROM 12 of FIG. 2 or the ROM 52 of FIG. 3 or the hard disk included in the recording section 18 of FIG. 2 or the recording section 55 of FIG. 3 which has the program recorded therein or thereon and is provided to a user in a form wherein it is incorporated in an apparatus body in advance.

It is to be noted that, in the present specification, the steps which describe the program recorded in or on a recording medium may be but need not necessarily be processed in a time series in the order as described, and include processes which are executed parallelly or individually without being processed in a time series.

Further, in the present specification, the term “system” is used to represent an entire apparatus composed of a plurality of apparatus or processing sections.

Furthermore, while the communication section 19 of FIG. 2 is formed as a component of the communication apparatus 1 in the example described hereinabove, it is otherwise possible to form the communication section 19 as one apparatus as seen from the example of the configuration of FIG. 3. In other words, for example, it is possible to construct the communication section 19 of FIG. 2 as an apparatus which can be removably mounted on the communication apparatus 1. In this instance, the communication section 19 can be mounted as an end point not only on the communication apparatus 1 but also on various apparatus and execute such various processes as described hereinabove for performing network communication.

While a preferred embodiment of the present invention has been described using specific terms, such description is for illustrative purposes only, and it is to be understood that changes and variations may be made without departing from the spirit or scope of the following claims.

What is claimed is:

1. An information processing apparatus which functions, in a network environment wherein data is communicated between a server and a client, as an end point on the server side or the client side, comprising:
a setter configured to set at least a permissible maximum latency as a parameter representative of a nature of the network which is to be used on the client side; and
a controller configured to perform real time control of data of an object of transmission or reception based on the parameter set by said setter to control a transmission or reception process of the data.

2. The information processing apparatus according to claim 1, wherein said setter further sets a priority degree as another parameter.

3. The information processing apparatus according to claim 2, wherein said setter further sets a used band as a further parameter.

4. The information processing apparatus according to claim 1, wherein said information processing apparatus functions as an end point on the client side and further comprises a generator configured to generate notification data for notifying the server side of the parameter set by said setter as one of data of the transmission object.

5. The information processing apparatus according to claim 4, wherein said generator performs a packetization process according to the Transmission Control Protocol/Internet Protocol or the User Datagram Protocol/Internet Protocol to generate the notification data as a packet.

6. The information processing apparatus according to claim 5, wherein a predetermined one port number is allocated in advance to each of values which can be taken by the parameter;
said setter converting each of the set values of the parameter into a port number coordinated with the value;
said generator generating the packet of the notification data using a socket which includes the port number converted from the value of the parameter by said setter.

7. The information processing apparatus according to claim 5, wherein said generator generates a packet wherein the value of the parameter set by said setter is described in a data region as the notification data.

8. The information processing apparatus according to claim 1, wherein said information processing apparatus functions as an end point on the server side, and
when said information processing apparatus receives, from the client side, data obtained by converting the parameter set by the client side into data of a form in which the data is transmitted and received in the network environment, said setter sets the parameter based on the received data.

9. An information processing method for an information processing apparatus which functions, in a network environment wherein data is communicated between a server and a client, as an end point on the server side or the client side, comprising the steps of:
setting at least a permissible maximum latency as a parameter representative of a nature of the network which is to be used on the client side; and
performing real time control of data of an object of transmission or reception based on the set parameter to control a transmission or reception process of the data.

10. A program for being executed by a computer which controls, in a network environment wherein data is communicated between a server and a client, an end point on the server side or the client side, comprising the steps of:
setting at least a permissible maximum latency as a parameter representative of a nature of the network which is to be used on the client side; and
performing real time control of data of an object of transmission or reception based on the set parameter to control a transmission or reception process of the data.
